(19) United States
(12) Patent Application Publication
(10) Pub. No.: US 2020/0012732 A1
(43) Pub. Date: Jan. 9, 2020

(54) INFORMATION MANAGEMENT SYSTEM AND PROCESS

(71) Applicant: French Company LLC, Twinsburg, OH (US)

(72) Inventor: Troy Lee Batchelor, III, Tomball, TX (US)

(21) Appl. No.: 16/026,105

(22) Filed: Jul. 3, 2018

(51) Int. Cl. G06F 17/30; G06K 9/00; H04N 5/232; H04N 7/18

(52) U.S. Cl. CPC G06F 17/30241; G06F 17/30268; H04N 7/181; G06K 9/00637; H04N 5/23238; G06F 17/30274

(57) ABSTRACT

This disclosure is of an information management system that includes a first computer programmed to: receive (a) observation data resulting from observation of a physical location, and (b) at least one associated visual image of the physical location; link the received observation data and the at least one associated visual image; and display the observation data and the at least one associated visual image.

### I. BACKGROUND

This invention pertains to the art of systems and processes for acquiring and managing information about physical locations. Physical locations may be observed or inspected, and information resulting from the inspection may be saved for later review. To improve the utility and ease of use of that information, this system and process are disclosed.

### II. SUMMARY

In accordance with one aspect of the present invention, an information management system includes a first computer programmed to: receive (a) observation data resulting from observation of a physical location, and (b) at least one associated visual image of the physical location; link the received observation data and the at least one associated visual image; and display the observation data and the at least one associated visual image.

In accordance with another aspect of the present invention, an information management system includes: a first computer, a second computer, and a third computer, wherein: the first computer and the second computer are programmed to communicate together wirelessly; the first computer and the third computer are programmed to communicate together; the second computer is portable and is further programmed to: determine the second computer's location; capture observation data for a plurality of points around a plurality of physical locations; capture at least one photograph for at least one of the plurality of points; link each captured photograph and the captured observation data for the respective point; record as part of the observation data the second computer's location each time the second computer captures a photograph linked to an observation and associate that recorded location with that photograph; and transmit the captured observation data and the at least one linked photograph to the first computer; and the third computer is further programmed to: receive from the first computer the captured observation data and the at least one linked photograph transmitted from the second computer; display the observation data in a table; display any photographs linked to the respective observation data when that respective observation data is selected; filter and search through the received observation data and the received at least one linked photograph and display results of the filtering and searching; display a first map or aerial image with a first icon at each physical location regarding which observation data has been received or is to be received; display a second map or aerial image of any selected one of the plurality of physical locations; when displaying the second map or aerial image of the selected physical location, display a second icon on the second map or aerial image at each point around the physical location where at least one received photograph was captured; when a second icon on the second map or aerial image is selected, display the at least one photograph captured for the point represented by the selected second icon; and display on the second map or aerial image an overlaid diagram of an interior of the physical location if the physical location is enclosed.

In accordance with still another aspect of the present invention, an information management process includes the steps of: (a) inspecting a physical location at multiple points around the physical location and capturing resulting observations as observation data; (b) capturing at least one visual image for at least one of the multiple points; (c) linking each visual image with the observation data from the respective point; (d) for each captured visual image, recording the location of the visual image's respective point as part of the observation data linked to that visual image; (e) displaying a first map or aerial image of the physical location; (f) on the first map or aerial image, displaying a first icon at each point around the physical location where at least one visual image was captured; and (g) when a first icon is selected, displaying the at least one visual image captured for the point represented by the selected first icon.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a perspective view of a physical location.

FIG. 2 shows a tablet with questions an inspector is to answer or observations the inspector is to make.

FIG. 3 shows a tablet prompting an observation that the inspector is to make.

FIG. 4 shows a tablet allowing the inspector to confirm the accuracy of the tablet's location.

FIG. 5 is a system architecture diagram of one embodiment of an information management system.

FIG. 6 shows a tablet displaying multiple inspections.

FIG. 7 shows software displaying an aerial image showing all physical locations that were or are to be inspected.

FIG. 8 shows software displaying an aerial image of one inspected physical location.

FIG. 9 shows software displaying the aerial image of FIG. 8, with an overlaid diagram of the interior of the inspected physical location.

FIG. 10 shows software displaying the aerial image of FIG. 9 with icons showing where observations were made with respect to that physical location.

FIG. 11 shows software displaying the aerial image of FIG. 10 in one frame and a photograph taken at a selected point in another frame.

FIG. 12 shows software displaying observations in a table format according to one embodiment.

FIG. 13 shows software displaying observations in a table format according to another embodiment.

FIG. 14 shows software displaying the table of FIG. 13 with a photograph of a selected observation.

### IV. DETAILED DESCRIPTION

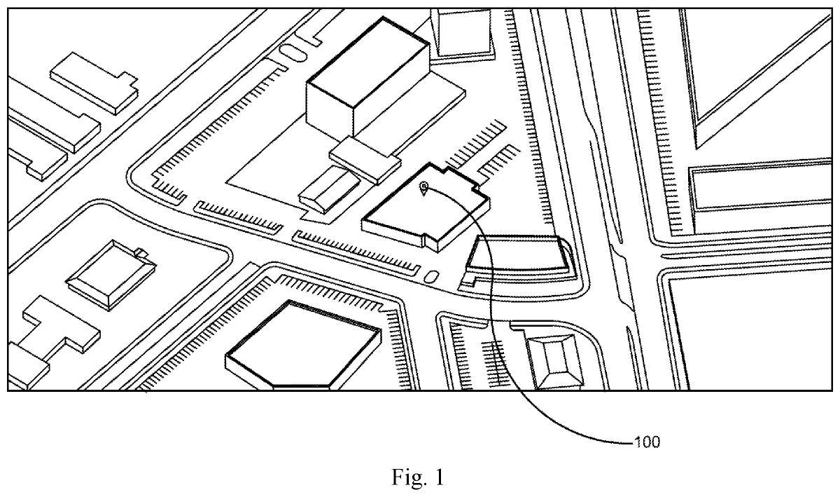

Referring now to the drawings wherein the showings are for purposes of illustrating embodiments of the invention only and not for purposes of limiting the same, and wherein like reference numerals are understood to refer to like components, FIG. 1 shows a perspective view of a physical location 100 to be inspected. The physical location 100 may be a building, a store, a restaurant, a factory, a manufacturing plant, a house, an apartment, a hotel, a gas station, a stadium, or any other enclosed location. The physical location 100 may also be one that is not enclosed, such as, but not limited to, a park, a road, or an airport runway. In one embodiment, the physical location 100 may be observed and inspected by an individual physically visiting the location 100. Observation and inspection are used interchangeably herein. In alternative embodiments, the physical location 100 may be inspected by using cameras at the location 100 or satellite or aerial imagery of the location 100. The individual inspecting the physical location 100 is called the inspector herein.

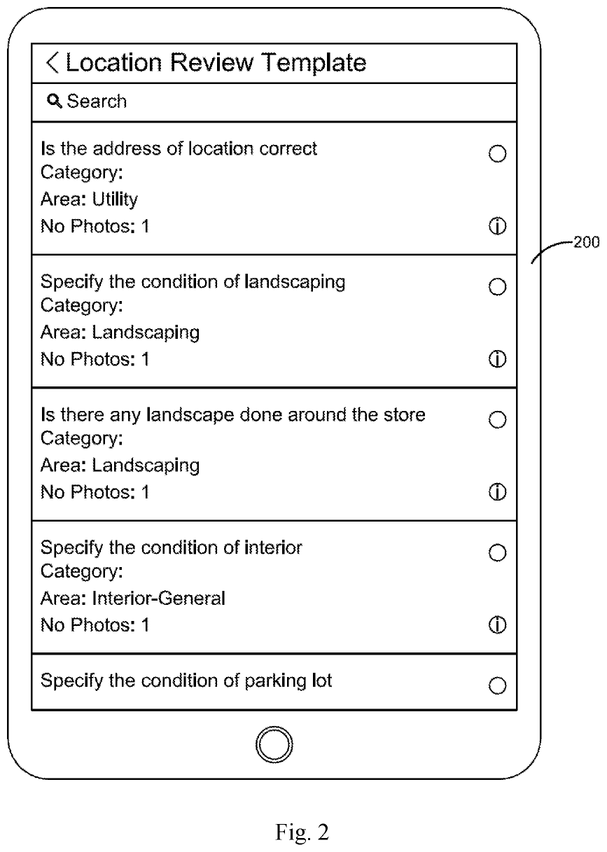

FIG. 2 shows a tablet 200 that may be used by the inspector during inspection of the physical location 100. In alternative embodiments, the inspector may use other devices, such as, but not limited to, a smartphone, a laptop, a personal digital assistant (PDA), or any other suitable computer or computing device. On arriving at the physical location 100, the inspector may observe the location 100 and record his observations using the tablet 200. In one embodiment, the tablet 200 may contain a list of previously created questions that the inspector is to answer during an inspection. Questions may ask, for example, about the condition of the location's parking lot, the condition of the building exterior, the lighting conditions, the conditions of the building interior, the conditions of the location's landscaping, and the condition of the location's signage. When one question is answered, the next question may come up for answering until all questions for that inspection are answered. This mode of inspection may be called the assigned survey mode. In one embodiment, the list of questions may be prepared by the person (individual or entity) conducting the inspections. In another embodiment (e.g., if the person conducting the inspections is doing so for its customers rather than for itself), the list of questions may be prepared by someone else (e.g., each customer can provide its list of questions). In another embodiment, the tablet 200 may allow the inspector to himself enter his observations according to his judgment (rather than prompting the inspector to answer specific questions). This mode of inspection may be called the ad-hoc survey mode.

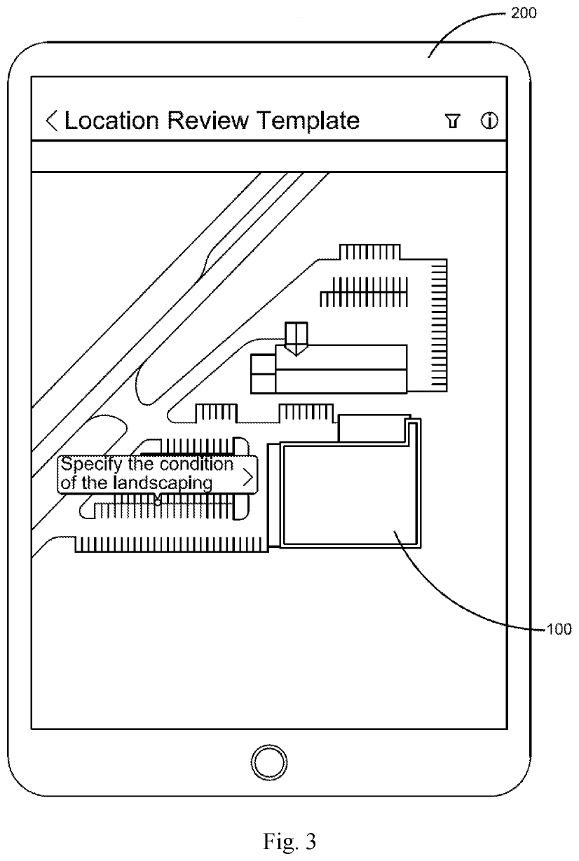

If in the assigned survey mode, the tablet 200 may show a question that the inspector is to answer, as shown in FIG. 3. For example, the question may ask about the condition of the physical location's landscaping. The inspector may observe and evaluate the physical location 100 and record his observation using the tablet 200. In one embodiment, the tablet 200 may provide a field for free-form entry of text. In another embodiment, the tablet 200 may provide a certain number of pre-set options, where the inspector may select only one. For example, when asking about the quality of landscaping, the answer options may be: excellent, good, fair, and poor. In another embodiment, the tablet 200 may provide multiple options, where the inspector may choose more than one.

In another embodiment, if action is required regarding the question asked, the inspector may indicate that action is required (and may further indicate what that action should be). For example, if observing the lighting of a store sign, the inspector may indicate the general condition (e.g., good, fair, or poor), and if a lightbulb in the sign has burned out, the inspector may indicate that action is required (and may further indicate that a lightbulb in the sign needs to be replaced). The recorded answer or observation (with or without indication if action is required) may be called observation data.

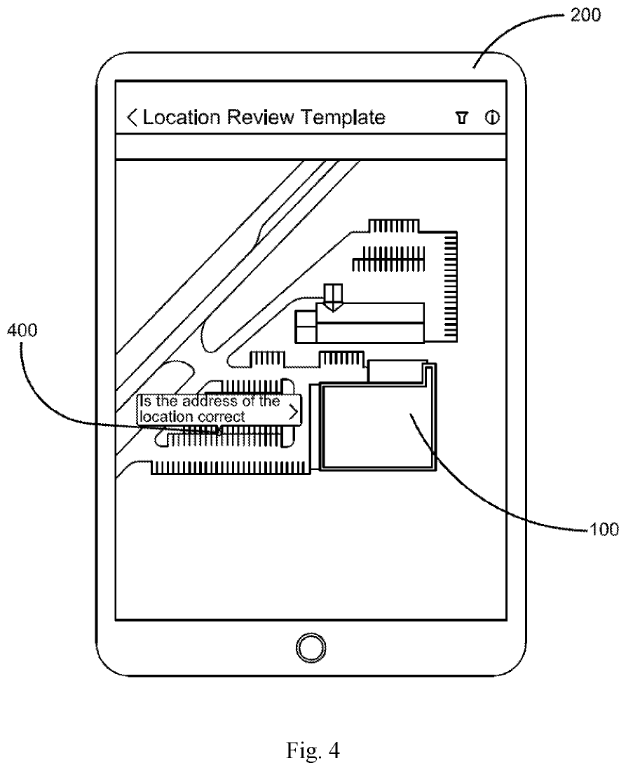

Before or after recording an observation, the tablet 200 may show the tablet's location 400 (e.g., by a pin on a map or an aerial image) and allow the inspector to confirm the accuracy of the location 400, as shown in FIG. 4. The tablet's (and thus the inspector's, if the inspector is onsite with the tablet 200) location 400 may be determined by using the GPS circuitry of the tablet 200. In alternative embodiments, the tablet's location 400 may be determined by using triangulation techniques from cell phone towers, wireless network points, or any other location detection methods. If the indicated tablet location 400 is not accurate (including, e.g., due to tolerances in triangulation), the inspector may move the location indicator (e.g., pin 400) to the precise location.

When recording an observation, the inspector may use the tablet 200 to take a photograph 1102 of the physical location 100 at the tablet's location 400. In one embodiment, the inspector may take just one photograph 1102. In another embodiment, the inspector may take multiple photographs 1102. In one embodiment, the tablet 200 may indicate to the inspector to take a certain number of photographs 1102 or in a certain way. In another embodiment, the inspector may exercise his judgment as to the number of photographs 1102 to be taken. In another embodiment, the inspector may take a complete 360-degree view of photographs 1102 at the tablet location 400. The at least one photograph 1102 taken may be linked to the recorded observation at that location 400. The at least one linked photograph 1102 may provide context for the recorded observation. For example, if the inspector observes the condition of the front door (as prompted by a question on the tablet 200), the inspector may record his observation and may take a photograph 1102 of the front door, which photograph 1102 may become linked to that observation. In another embodiment, the inspector may capture a 360-degree view 1102 at the tablet location 400 and may further capture one or more “flat” (i.e., non-360-degree-view) photographs 1102 of a particular area of concern where action is required. For example, if observing the exterior of a restaurant, the inspector may record 360-degree views 1102 at various points around the restaurant's exterior and may further take additional photographs 1102 of the restaurant's sign if its lightbulb has burned out and needs to be replaced. In other embodiments, the inspector may record observations using the tablet 200 and use a separate camera to take photographs 1102, linking the observations and photographs 1102 subsequently. In another embodiment, the inspector may record a video instead of or in addition to a photograph 1102 (the video or photograph 1102 collectively referred to as a visual image).

In one embodiment, a question may allow or require making multiple observations. In another embodiment, multiple similar questions may each require or allow making one observation. For example, one or multiple questions regarding a physical location's parking lot may allow the inspector to go to multiple points on the parking lot (e.g., northernmost point, southernmost point, westernmost point, and easternmost point), record observations about the parking lot at each of the multiple points, and take one or more photographs 1102 of the parking lot at each point. The inspector may also confirm the precise point at which each of these observations was made. In another embodiment, each captured photograph 1102 (or video) may include a geotag that describes the geographical location where that photograph 1102 was taken. The photograph geotag may be used to determine where the observation associated with that photograph 1102 was made. The geotag may be used to link its photograph 1102 (and linked observation) to a map.

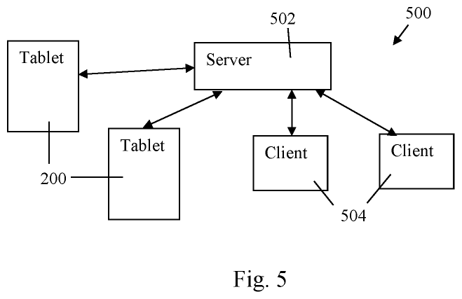

FIG. 5 shows a diagram of one embodiment of an information management system 500. This embodiment includes more than one tablet 200 that may be used by inspectors to record observations about physical locations 100. Each tablet 200 may connect with a server 502 to transfer data between the two. For example, a tablet 200 may send the recorded observations (including photographs 1102) to the server 502. In one embodiment, the list of questions for the inspector may be loaded onto the tablet 200. In another embodiment, the list of questions for the inspector may be stored on the server 502 and retrieved by the inspector's tablet 200. In one embodiment, one inspector using one tablet 200 may view observations recorded by another inspector using another tablet 200.

With continuing reference to FIG. 5, the system 500 may include one or more clients 504 that may be used to review the recorded observations and to configure the questions to be answered or observations to be made. Similar to the previous discussion regarding the tablet 200, the client 504 may be a desktop computer, a laptop, a smartphone, a tablet, a PDA, or any other computer or computing device. In one embodiment, the functionality and capability of a tablet 200 and a client 504 may be interchangeable, except that a tablet 200 may be better suited and more convenient for making inspections (e.g., because of portability, smaller size, and lighter weight) and a client 504 may be better suited and more convenient for viewing the results of inspections (e.g., because of a larger screen). Where multiple inspectors have recorded observations about multiple physical locations 100, the resulting data may be available for review by a client 504 and/or server 502.

With continuing reference to FIG. 5, the tablets 200 server 502, and clients 504 may communicate by wired or wireless communication means. Examples include, but are not limited to, local area network, wide area network, Ethernet, Internet, the wireless local area networking protocol used by devices certified under the certification mark WI-FI®, the telecommunication and computer protocol used by devices certified under the certification mark BLUETOOTH®, GSM, CDMA, and LTE. In one embodiment, the server 502 is stored in the cloud. In another embodiment, the communication is via virtual private networking (VPN). In one embodiment, the data is communicated among the devices in real-time as it is being entered or captured. In another embodiment, each tablet 200 must be physically connected to and synchronized with the server 502.

In an alternative embodiment to the system 500 shown in FIG. 5, the system 500 includes only one computer acting as the server and client(s) (i.e., the system 500 includes just one server-client computer and at least one tablet 200). In another alternative embodiment, the system 500 includes only one computer that performs all system functions (i.e., recording observations and reviewing them).

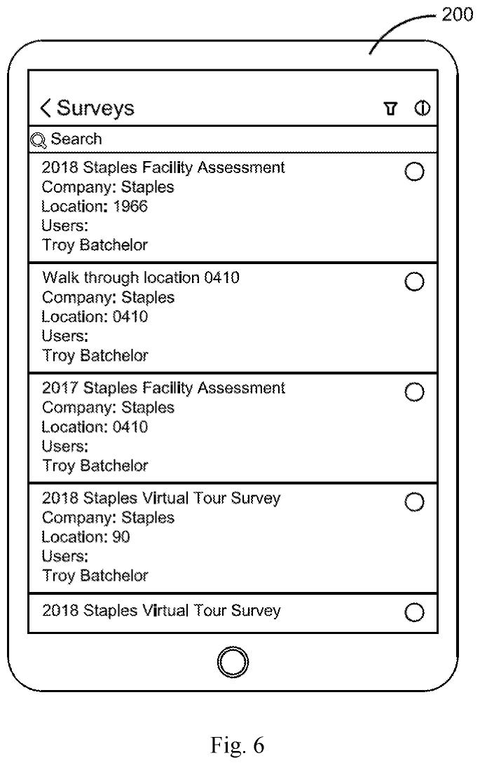

An inspector may perform inspections at multiple physical locations 100. Likewise, an inspector may perform inspections for multiple persons (e.g., multiple customers). An inspector may also perform multiple inspections at the same physical location 100 (e.g., annual inspections). FIG. 6 shows a tablet 200 displaying multiple inspections that can be or have been performed.

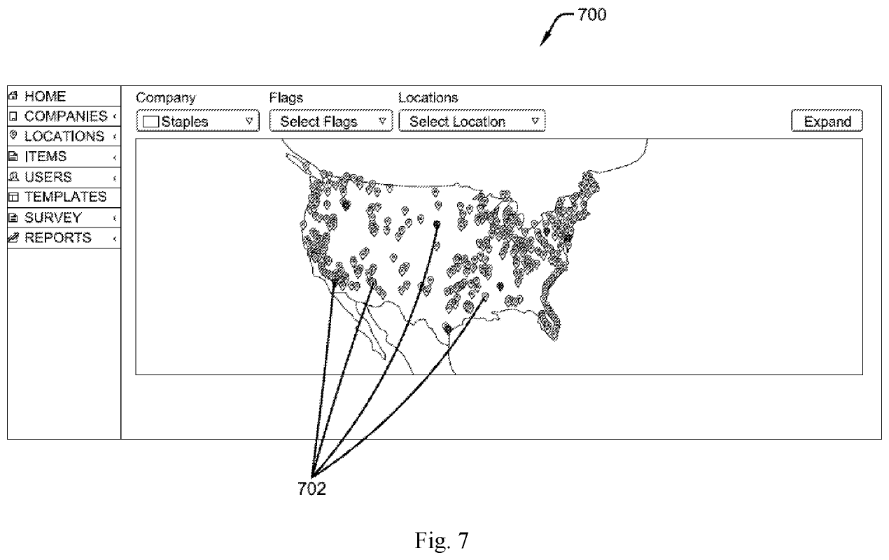

FIG. 7 shows one embodiment of software 700 that can be used to review the recorded observation data. The software 700 may display a map or aerial image that shows where each physical location 100 to be inspected is. For example, if the user of the software 700 is a company with multiple physical locations (e.g., a chain of stores with multiple locations), the software 700 may display the location of each store. As another example, if the user of the software 700 is a company that provides inspection services to customers, the software 700 may display the location of each customer facility inspected. The software user may zoom and pan the image (whether map or aerial photograph) to display the area of interest, including down to just one physical location 100.

With continued reference to FIG. 7, each physical location 100 may be indicated by an icon (e.g., pin) 702 that may show additional information about that location 100. For example, a physical location 100 that has not yet been inspected may be indicated by a pin 702 of one color (e.g., gray). A physical location 100 that has been inspected with satisfactory results and no action required may be indicated by a pin 702 of another color (e.g., green). A physical location 100 that has been inspected with action required may be indicated by a pin 702 of yet another color (e.g., red for a safety issue or orange for a non-safety issue). In alternative embodiments, different icon shapes may be used instead of icon colors, or a combination of both shapes and colors may be used. By showing this information, the software 700 may allow a user to see geographical trends among the applicable physical locations 100 (e.g., a certain geographical area needs to be or has been inspected; a certain geographical area is problematic or satisfactory). The software 700 may allow the user to filter the displayed icons 702. The software 700 may allow display of only certain icons 702 or may hide only certain icons 702. For example, the software 700 may display only physical locations 100 that require action, or the software may hide inspected physical locations 100.

With continued reference to FIG. 7, the software 700 may allow the filtering of physical locations 100 that are associated. For example, if the software user is a servicing company that has multiple customers, the software 700 may allow the user to select a certain customer (or customers) and will display only the physical location(s) 100 associated with that customer or customers. The software 700 may also filter out all except one desired physical location 100. The software filtering ability may be cumulative. In other words, the software 700 may allow filtering both by icon 702 (described in the preceding paragraph) and by company/customer/location (described in this paragraph).

The software 700 may also display a summary of the total number of inspections or surveys completed and remaining for the applicable time period (e.g., the current year or quarter). The software 700 may also display a summary of the number of physical locations 100 where an inspection has indicated that action was required or that the inspection results were satisfactory.

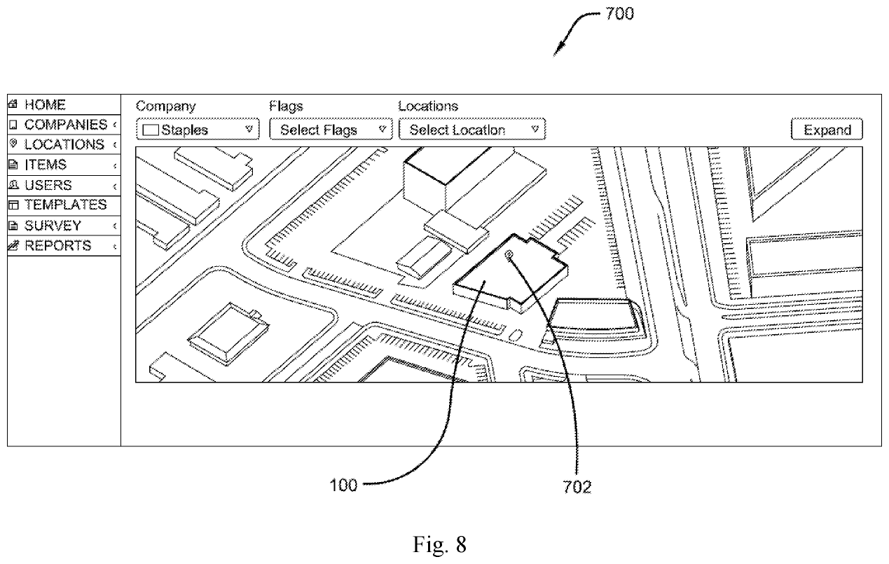

In one embodiment, the software 700 may display additional information about a physical location 100 in a popup if a pointer (e.g., mouse cursor) hovers over that location's icon 702. The software 700 may also allow selection of a physical location 100 to display additional information about that location 100. In one embodiment, selecting the icon 702 representing the physical location 100 on the map or aerial image may zoom the map or aerial image to focus just on the selected location 100 and may bring up additional information about that location 100, as shown in FIG. 8.

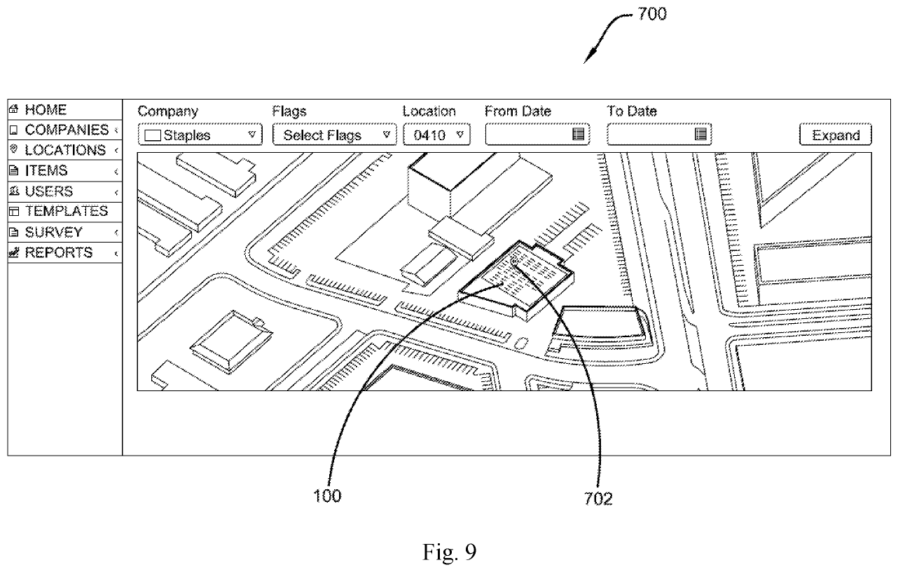

In one embodiment, where the physical location 100 is enclosed (e.g., a building), the software 700 may display a map or diagram of the interior of the building, as shown in FIG. 9. If the map or aerial image shows the outline or exterior of a building, the software 700 may overlay a diagram of the building's interior on top of the outline or exterior so that the software user can visualize the interior of the building in relation to the map or aerial view. For example, if the physical location 100 is a store, the overlay diagram may show aisles inside the store, the store's warehouse area, and the store entrances and exits. The interior diagrams may be obtained from public records or from the owners or occupants of the enclosed physical locations 100.

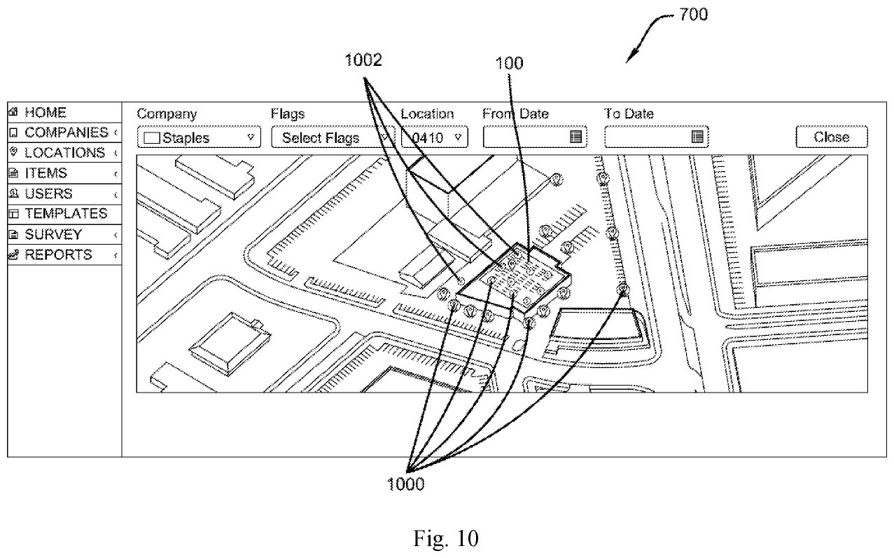

When viewing information about a physical location 100, the software 700 may show the various points 1000 around the physical location 100 that have been observed (as discussed previously), as shown in FIG. 10. In one embodiment, if multiple points 1000 are very close together on the map or aerial image (e.g., because it is zoomed out sufficiently), the software 700 may aggregate the multiple points 1000 into one icon 1002 (rather than showing one icon per point 1000) that includes a number specifying how many points 1000 have been aggregated into that icon 1002, as shown in FIG. 10. When the software user zooms in on the map or aerial image such that the multiple points 1000 are no longer too close together, the software 700 may separate the aggregate icon 1002 into multiple points 1000. In another embodiment, the icons representing points 1000 inside a building or enclosure may be different from icons representing points 1000 outside the building or enclosure.

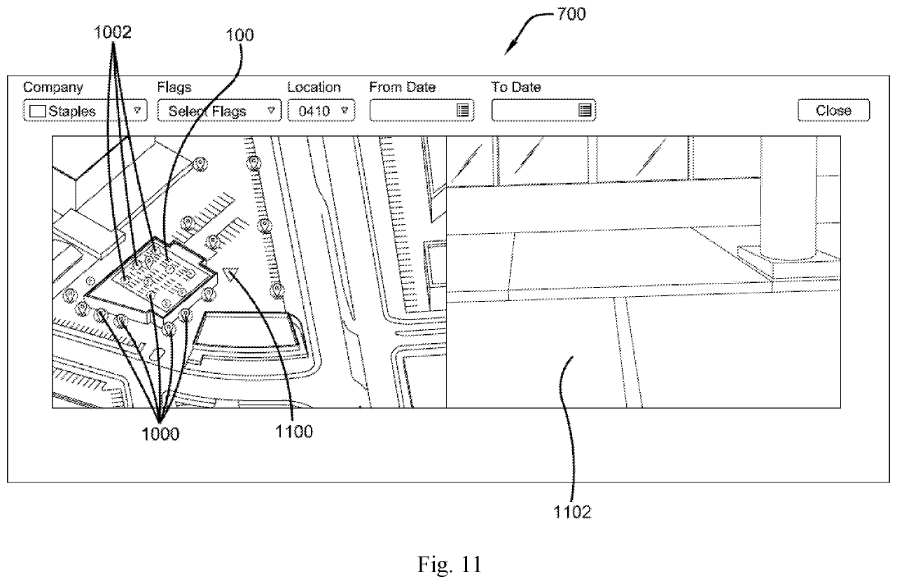

Clicking on any icon representing a point 1000 may show additional information about that point 1000. In one embodiment, clicking on a point 1000 may show a photograph 1102 taken at that point 1000, as shown in FIG. 11. In one embodiment, the software 700 may show a split view, where one frame shows the physical location 100 and its points 1000 and where another frame shows the photograph 1102 of the selected point 1100. In another embodiment, the two views may appear in separate windows, each of which may be resized, maximized, and moved on the screen. If a point 1000 is selected, the icon 1100 representing that point 1000 may change (e.g., in color, shape, or size) to indicate to the software user which point 1000 has been selected and is showing more information (e.g., which point 1000 is the displayed photograph 1102 linked to).

If a 360-degree view of photographs 1102 was taken at a point 1000, the software user may rotate through the entire view 1102 to see how the physical location 100 looked during inspection from the perspective of the point 1000. In one embodiment, as the software user is rotating through the 360-degree view of photographs 1102 taken at a point 1000, the icon 1100 representing that point may indicate the direction of view currently being looked at. For example, if the user clicks on a point 1000 outside a store and is rotating through its 360-degree view of photographs 1102, when the user rotates the photographs 1102 to look at the store exterior, the icon 1100 may point toward the store exterior, and when the user rotates the photographs 1102 to look away from the store and toward the parking lot exit, the icon 1100 may point toward the parking lot exit. This function may provide perspective to a user regarding what the photographs 1102 show. In an alternative embodiment, the software 700 may use the photographs 1102 captured at the various points 1000 to allow the software user to take a virtual tour of the inspected physical location 100. In one embodiment, the icons representing points 1000 with a 360-degree view of photographs 1102 may be different from icons representing points 1000 without a 360-degree view of photographs 1102 (e.g., only “flat” photographs 1102).

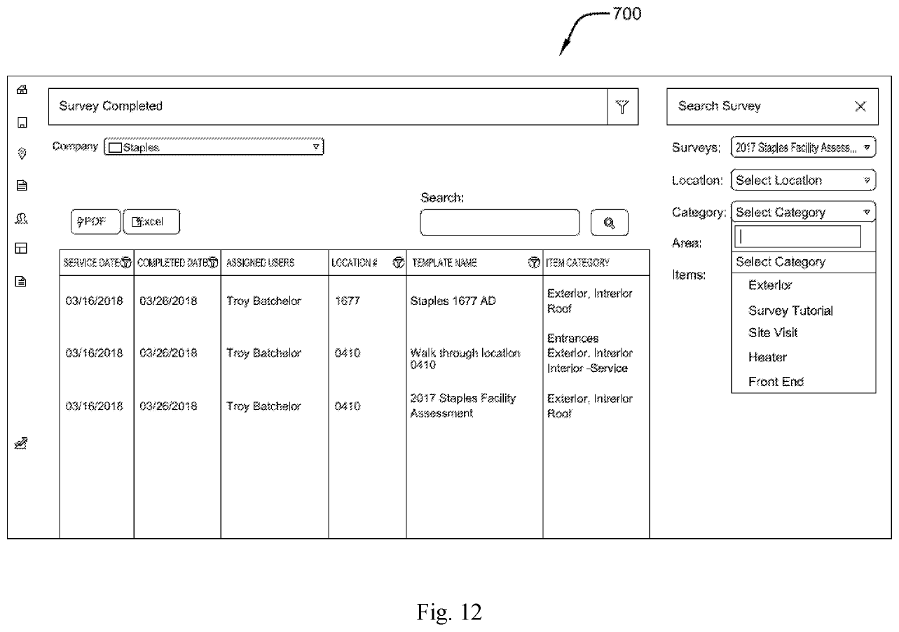

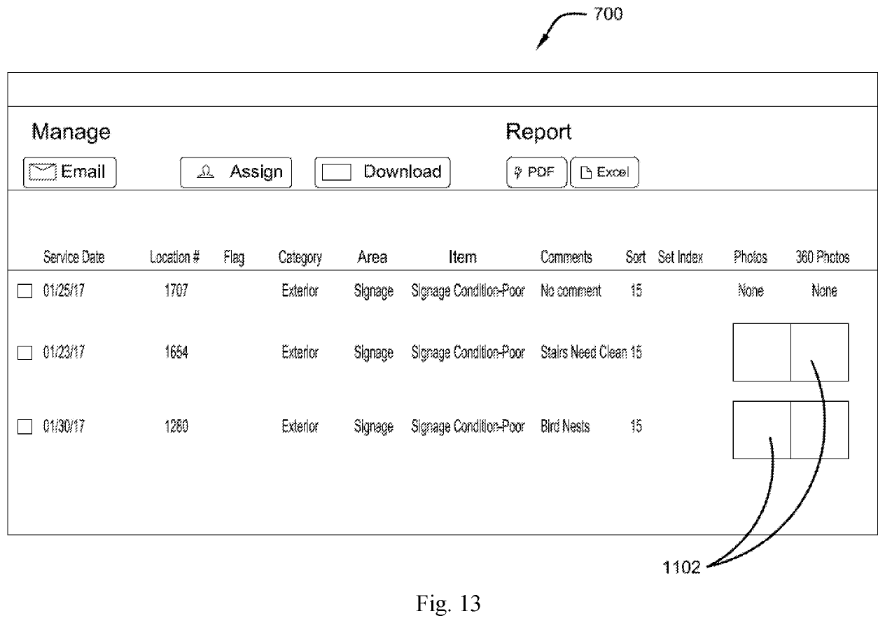

The software 700 may also allow its user to review and filter all observation data in a table-like format (rather than a map-like format, as discussed above), as shown in FIGS. 12 and 13. The user may filter all inspection data by various criteria. For example, the software may display only the observations from: one physical location 100; all physical locations 100 performed within a certain date range; the exteriors of physical locations 100; the frontage of physical locations 100; all physical locations 100 of one customer (if the software user inspects multiple customers). The filtering criteria may be cumulative (i.e., the software may allow the user to filter using multiple criteria). The software 700 may allow the user to search through all data for keywords and may filter the results to observations that include the keywords.

The software 700 may display certain information about each observation. Examples may include: the date the observation was made, the identity of the inspector making the observation, the physical location 100 where the observation was made, a category designation for the observation (e.g., exterior, interior, roof, entrance), the inspector's comments, a set flag, and one or more thumbnails of photographs 1102 associated with that observation. The software 700 may allow information about observations to be shown in separate columns (with each observation being a separate row in the table), may allow customizing of the columns, and may allow sorting by any of the columns. The software may allow the resulting table to be exported, e.g., as a PDF or spreadsheet (e.g., XLS) file, or emailed. The software may also allow selecting certain rows of the filtered table (as opposed to the entire table) for exportation. In creating the list of questions for inspectors, the system user can consider any fields or criteria according to which the user may wish to filter the resulting observation data and may incorporate that criteria into the list of questions to allow subsequent filtering by that criteria.

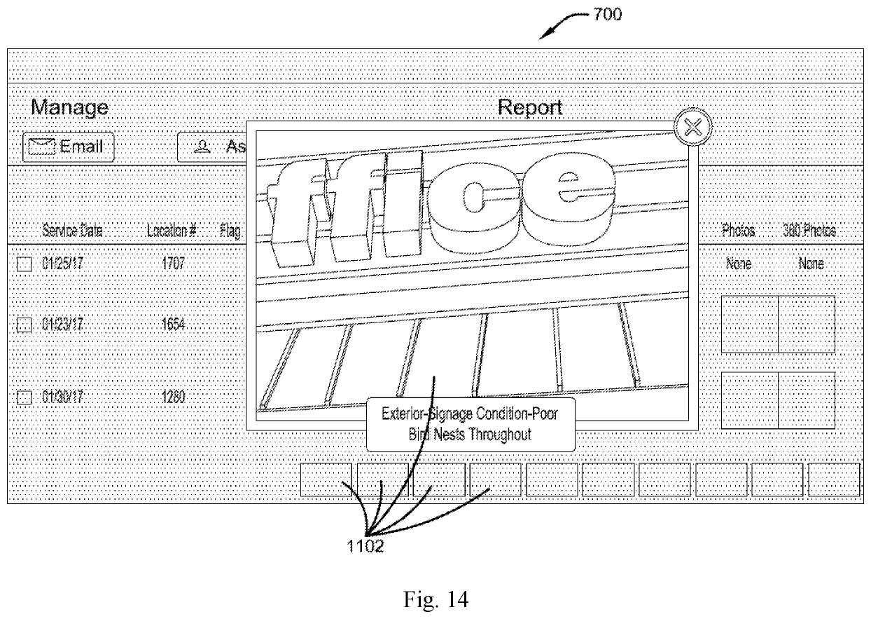

When an observation is selected in the table, the software 700 may provide additional information about that observation. For example, selecting an observation may display the photographs 1102 linked to that observation, as shown in FIG. 14. In one embodiment, the software 700 may open a new window to display the additional information about that observation. The software 700 may be used to see all recorded observations and related information that meet the filter criteria. For example, a user may wish to see the current condition of all store signs of all locations of that store chain. The software 700 may filter and display only observations (and their linked photographs 1102) that are associated with store signs of that store chain, where the observations were taken in the most recent inspection. The user can then go through the resulting observations and photographs 1102 to see how all of the store chain's signs look. For another example, the user may wish to see all store signs that are currently in poor condition. The software 700 may filter and display observations made in the most recent inspection where the store sign condition was observed to be poor. In one embodiment, exporting or emailing the observation results also includes the additional information about the included observations.

In another embodiment, when a software user is reviewing filtered observations in the table, selecting an observation may open a map or aerial image showing the physical location 100 and the point 1100 where that selected observation was made, for example as in FIG. 11. The user may then click on additional points 1000 for that physical location 100 to see additional observations, as explained above.

The ability to filter and review observations helps managers or owners quickly inspect physical locations 100 remotely. The observations gathered by inspectors is used as the initial evidence of the conditions of the physical locations 100. If those observations indicate that action is required at a certain physical location 100, the owners or managers of that physical location 100 can then physically visit that location 100 to confirm that action is required. This system 500 and process helps narrow the number of physical locations 100 that managers or owners have to physically visit.

In one embodiment, the software running on the tablets 200, server 502, or clients 504 may be sold or licensed for local installation on those devices. In another embodiment, that software may be licensed on a Software-as-a-Service model. The disclosed system 500 and process may be used in areas that include, but are not limited to, real estate, restaurants, stores, construction, maintenance.

Numerous embodiments have been described, hereinabove. It will be apparent to those skilled in the art that the above methods and apparatuses may incorporate changes and modifications without departing from the general scope of this invention. Aspects of the various disclosed embodiments may be combined. It is intended to include all such modifications and alterations in so far as they come within the scope of the appended claims or the equivalents thereof.

Having thus described the invention, it is now claimed:

I/We claim:

1. An information management system comprising:
a first computer programmed to:
receive (a) observation data resulting from observation of a physical location, and (b) at least one associated visual image of the physical location;
link the received observation data and the at least one associated visual image; and
display the observation data and the at least one associated visual image.

2. The information management system of claim 1, wherein the at least one visual image comprises at least one photograph.

3. The information management system of claim 2, wherein:
the received observation data comprises data from observations made at multiple points around the physical location;
at least one received photograph is captured for at least one of the multiple points; and
each received photograph captured for one of the multiple points is linked to the observation data for that associated point.

4. The information management system of claim 3, wherein:
the displayed observation data is displayed in a table, and
the first computer is further programmed to:
display any photographs linked to the respective observation data when that respective observation data is selected; and
filter and search through the received observation data and the received at least one associated photograph and display results of the filtering and searching.

5. The information management system of claim 4, wherein the first computer is further programmed to:
display a map or aerial image of the physical location;
display a first icon on the map or aerial image at each point around the physical location where at least one received photograph was captured; and
when a first icon on the map or aerial image is selected, display the at least one photograph captured for the point represented by the selected first icon.

6. The information management system of claim 5, wherein the first computer is further programmed to display on the map or aerial image an overlaid diagram of an interior of the physical location if the physical location is enclosed.

7. The information management system of claim 6, wherein the first computer is further programmed to:
receive observation data and at least one associated photograph for a plurality of physical locations; and
display a map or aerial image with a second icon at each physical location regarding which observation data has been received or is to be received.

8. The information management system of claim 7, wherein:
the observation data comprises (a) information regarding the condition of the observed physical location, and (b) information whether action is required with regard to the observed physical location; and
the first computer is further programmed to:
associate physical locations among a plurality of persons; and
filter the second icons for physical locations displayed on the map or aerial image based on (i) the observation data for the physical locations, or (ii) the plurality of associated persons.

9. The information management system of claim 8, wherein the second icons for physical locations displayed on the map or aerial image differ based on (a) the information regarding the condition of the observed physical locations, and (b) the information whether action is required with regard to the observed physical locations.

10. The information management system of claim 8, wherein:
for each one of the multiple points around any physical location where at least one received photograph is captured, at least one photograph is a 360-degree view of photographs.

11. The information management system of claim 10 further comprising a second computer programmed to:
capture the observation data and the at least one associated photograph; and
transmit the captured observation data and the at least one associated photograph to the first computer;
wherein the first computer and the second computer are further programmed to communicate together.

12. The information management system of claim 11 further comprising a third computer programmed to:
receive the observation data and the at least one associated photograph from the first computer; and
display the observation data and the at least one associated photograph;
wherein the first computer and the third computer are further programmed to communicate together.

13. The information management system of claim 11, wherein the second computer is portable and is further programmed to:
display a plurality of questions to be answered or observations to be made; and
allow capturing at least one photograph for each question to be answered or observation to be made.

14. The information management system of claim 13, wherein the second computer communicates with the first computer wirelessly and is further programmed to:
determine the second computer's location; and
record as part of the observation data the second computer's location each time the second computer captures a photograph associated with an observation and associate that recorded location with that photograph.

15. An information management system comprising:
a first computer;
a second computer; and
a third computer;
wherein:
the first computer and the second computer are programmed to communicate together wirelessly;
the first computer and the third computer are programmed to communicate together;
the second computer is portable and is further programmed to:
determine the second computer's location;
capture observation data for a plurality of points around a plurality of physical locations;
capture at least one photograph for at least one of the plurality of points;
link each captured photograph and the captured observation data for the respective point;
record as part of the observation data the second computer's location each time the second computer captures a photograph linked to an observation and associate that recorded location with that photograph; and
transmit the captured observation data and the at least one linked photograph to the first computer; and
the third computer is further programmed to:
receive from the first computer the captured observation data and the at least one linked photograph transmitted from the second computer;
display the observation data in a table;
display any photographs linked to the respective observation data when that respective observation data is selected;
filter and search through the received observation data and the received at least one linked photograph and display results of the filtering and searching;
display a first map or aerial image with a first icon at each physical location regarding which observation data has been received or is to be received;
display a second map or aerial image of any selected one of the plurality of physical locations;
when displaying the second map or aerial image of the selected physical location, display a second icon on the second map or aerial image at each point around the physical location where at least one received photograph was captured;
when a second icon on the second map or aerial image is selected, display the at least one photograph captured for the point represented by the selected second icon; and
display on the second map or aerial image an overlaid diagram of an interior of the physical location if the physical location is enclosed.

16. The information management system of claim 15, wherein:
the second computer is further programmed to:
display a plurality of questions to be answered or observations to be made; and
allow capturing at least one photograph for each question to be answered or observation to be made;
the captured observation data comprises (a) information regarding the condition of the observed physical location, and (b) information whether action is required with regard to the observed physical location; and
for each one of the plurality of points around any physical location where at least one received photograph is captured, at least one photograph is a 360-degree view of photographs.

17. The information management system of claim 16, wherein the third computer is further programmed to:
associate physical locations among a plurality of persons; and
filter the first icons for physical locations displayed on the first map or aerial image based on (i) the observation data for the physical locations, or (ii) the plurality of associated persons.

18. An information management process comprising the steps of:
(a) inspecting a physical location at multiple points around the physical location and capturing resulting observations as observation data;
(b) capturing at least one visual image for at least one of the multiple points;
(c) linking each visual image with the observation data from the respective point;
(d) for each captured visual image, recording the location of the visual image's respective point as part of the observation data linked to that visual image;
(e) displaying a first map or aerial image of the physical location;
(f) on the first map or aerial image, displaying a first icon at each point around the physical location where at least one visual image was captured; and
(g) when a first icon is selected, displaying the at least one visual image captured for the point represented by the selected first icon.

19. The information management process of claim 18 further comprising the steps of:
(h) repeating steps (a)-(d) for additional physical locations;
(i) displaying a second map or aerial image of multiple physical locations with a second icon at each physical location;
(j) filtering and searching through the observation data and linked visual images from all physical locations and displaying the results; and
(k) when any observation data is selected from the results of step (j), displaying any visual images linked to the selected observation data;
wherein steps (e)-(g) are performed with respect to any of the physical locations.

20. The information management process of claim 19, wherein:
step (a) further comprises displaying a plurality of questions to be answered or observations to be made before capturing the resulting observations;
step (e) further comprises displaying on the first map or aerial image an overlaid diagram of an interior of the physical location if the physical location is enclosed; and
the observation data captured in step (a) comprises information whether action is required with regard to the observed physical location.
